(19) United States
(12) Patent Application Publication
(10) Pub. No.: US 2010/0196726 A1
(43) Pub. Date: Aug. 5, 2010

(54) MAGNESIUM ALLOY MATERIAL, AND METHOD FOR TREATMENT OF SURFACE OF MAGNESIUM ALLOY MATERIAL

(76) Inventors: Kinue Tsunematsu, Saga (JP); Kozo Inoue, Saga (JP); Shuji Tsunematsu, Saga (JP); Michiru Sakamoto, Aichi (JP)

Correspondence Address: HARNESS, DICKEY & PIERCE, P.L.C., P.O. BOX 8910, RESTON, VA, 20195, US

(21) Appl. No.: 12/452,797

(22) PCT Filed: Jul. 23, 2008
(86) PCT No.: PCT/JP2008/063195

§ 371 Date: Apr. 5, 2010

(30) Foreign Application Priority Data
Jul. 27, 2007 (JP) 2007-196552
Jun. 4, 2008 (JP) 2008-147291

(51) Int. Cl. B32B 15/04; B05D 3/04; B05D 3/02

(52) U.S. Cl. 428/457; 427/377

(57) ABSTRACT

A magnesium alloy material contains a complex made from a phosphate-containing magnesium, such as dittmarite and the like, and magnesium hydroxide, the complex being formed by a steam curing of the magnesium alloy material conducted using (i) at least one compound chosen among diammonium hydrogen phosphate, ammonium dihydrogen phosphate, and triammonium phosphate, and (ii) water. In this way, it is possible to provide a magnesium alloy material having excellent corrosion resistance, shock resistance and the like, and to provide a method for treatment of surface of magnesium alloy material allowing the manufacture of a magnesium alloy material having excellent corrosion resistance, shock resistance and the like.

### TECHNICAL FIELD

The present invention relates to a magnesium alloy material and to a method for treatment of a surface of a magnesium alloy material (surface treatment method). More precisely, the present invention relates (i) to a magnesium alloy material having a surface on which a phosphate-containing component having good crystallinity, such as dittmarite and the like, is formed, and then is subjected to steam curing with diammonium hydrogen phosphate or the like so as to form a strong coating layer containing a composite of phosphate-containing magnesium, such as dittmarite and the like, and magnesium hydroxide, and (ii) to a surface treatment method allowing the formation of a phosphate-containing compound having good crystallinity, such as dittmarite and the like, on the surface of the magnesium alloy material, and performing steam curing conducted using diammonium hydrogen phosphate, so as to form a strong coating layer containing composite phosphate-containing magnesium, such as dittmarite and the like, and composite magnesium hydroxide.

### BACKGROUND ART

In general, magnesium, which is a base metal, is an extremely active metal. As a result, magnesium alloys containing magnesium in main proportions have a defect such as being likely to corrode due to surface oxidation and the like. It is therefore necessary to improve a corrosion resistance of magnesium alloys.

Methods to improve the corrosion resistance of a magnesium alloy include for example a method wherein a coating (for example an organic resin coating such as acrylic and the like) is directly applied on a surface of the magnesium alloy. However, the surface of the magnesium alloy is oxidized even when the magnesium alloy has been directly coated with a coating material. As a result, adhesiveness of the magnesium alloy and of a coating layer degrades, and the coating layer becomes likely to be peeled off.

Accordingly, as a preliminary step to applying the coating on the surface of the magnesium alloy, the adhesiveness of the magnesium alloy and of the coating layer is improved by performing in advance a surface treatment on the magnesium alloy.

Patent Literature 1, for example, discloses a surface treatment of a magnesium alloy, as follows: “in order to provide a surface treatment method of a magnesium base material making it possible to form at a low cost a layer having a high corrosion resistance, the magnesium base material made from magnesium or from a magnesium alloy is submitted to a heat treatment in a humid atmosphere, and a magnesium oxide layer is formed on the surface”.

The following is disclosed in Patent Literature 2: “in order to provide a method making it possible to perform economically and in an environmentally friendly manner a surface treatment of a magnesium or magnesium alloy product, a surface treatment method of a magnesium or magnesium alloy product in which the magnesium or magnesium alloy product is treated with a treatment liquid including diammonium hydrogen phosphate”. Further, Patent Literature 2 also discloses a technology as follows: “the surface treatment of the magnesium or magnesium alloy product using the treatment liquid is performed by putting in contact the treatment liquid with a surface of the magnesium or magnesium alloy product, for example by immersing the product into the treatment liquid or by spraying the treatment liquid onto the product”.

The following is disclosed in Patent Literature 3: “in order to provide a surface treatment method of a magnesium material or of a magnesium alloy material having a high corrosion resistance, which method does not use hazardous chromate, a surface treatment method of a magnesium material or of a magnesium alloy material in which, following a formation of an oxide layer by either a chemical method or an electrochemical method, a surface of the magnesium material or of the magnesium alloy material is treated in a high temperature steam atmosphere by using as a treatment liquid a neutral solution or an alkaline solution”. The following is also disclosed: “the steam treatment is performed in order to improve the corrosion resistance of the treated surface on which the oxide layer was formed”.

The following is disclosed in Patent Literature 4: “in order to provide a low-cost surface treatment method of a cast product having no harmful consequences on human health and to provide a cast product having a good adhesion to a corrosion prevention layer and including a surface-treated layer being corrosion-resistant by itself, a surface treatment method of a cast made by casting a magnesium or magnesium alloy and the like, in which the cast is surface-treated by a heating/pressuring treatment performed in an aqueous solution of phosphate and the like”. The following is also disclosed in Patent Literature 4: “alkali metal salt of metaphosphate, pyrophosphoric acid, phosphoric acid, triphosphate and tetraphosphate; ammonium salt; and compounds of amine salts and the like may be used as phosphate”.

The following is disclosed in Patent Literature 5: “in order to provide a surface treatment method of a magnesium material or of a magnesium alloy material using no pharmaceutical agent and having a high production efficiency, a surface treatment method includes the following steps: (i) a step of performing a wet blast treatment of a surface of a magnesium material or of a magnesium alloy material; and (ii) a step of performing a steam treatment, following step (i), by heat treating the magnesium material or the magnesium alloy material at a relative humidity of 80% or above. The following is also disclosed in Patent Literature 5: “The wording “wet blast treatment” refers to a treatment in which a mixture of an abrasive material (blast material) and water is sprayed onto a surface of an object of the treatment”.

### Citation List

Patent Literature 1

Japanese Patent Application Publication, Tokukai, No. 2006-28539 (Publication Date: Feb. 2, 2006)

Patent Literature 2

Japanese Patent Application Publication, Tokukaihei, No. 11-29874 (1999) (Publication Date: Feb. 2, 1999)

Patent Literature 3

Japanese Patent Application Publication, Tokukai, No. 2000-64057 (Publication Date: Feb. 29, 2000)

Patent Literature 4

Japanese Patent Application Publication, Tokukai, No. 2002-322567 (Publication Date: Nov. 8, 2002)

Patent Literature 5

Japanese Patent Application Publication, Tokukai, No. 2005-54238 (Publication Date: Mar. 3, 2005)

### SUMMARY OF INVENTION

However, with the surface treatment methods described in Patent Literatures 2 and 4, because a phosphate solution is used, impurities are mixed into the solution after the treatment. As a result, it is difficult to use the solution repeatedly after the surface treatment, and problems such as a cost increase and an increase in the number of steps occur.

Further, with the surface treatment methods of a magnesium alloy described in Patent Literatures 1, 3 and 5, the surface treatment is performed using steam. However, because the magnesium alloy material is only put in contact with the steam and several other steps (such as degreasing, coating or blast treatment) are necessary, such a problem occurs that the surface treatment does not have a satisfying efficiency.

In addition, with a surface treatment method in which a magnesium alloy material is treated using a generally used anodic oxidation method, because the anodic oxidation is performed by having an electric current pass into a solution, the following problems occur: a high potential is required if a coated layer of a surface of the magnesium alloy becomes thick, and because of this, a large-scale surface treatment device is necessary. Further, with the anodic oxidation method, because the coated layer is only attached onto the surface of the magnesium alloy material, the coated layer of the surface of the magnesium alloy material becomes cracked if the magnesium alloy material is bent. As a result, such a problem occurs that the magnesium alloy material on which the coated layer is attached by anodic oxidation cannot be easily put to practical use.

The present invention is attained in view of the above problems. An object of the present invention is to provide a magnesium alloy material having excellent corrosion resistance, shock resistance and the like, and to provide a surface treatment method of magnesium alloy material allowing the manufacture of a magnesium alloy material having excellent corrosion resistance, shock resistance and the like.

In order to solve the above problems, a magnesium alloy material in accordance with the present invention contains a complex made from phosphate-containing magnesium and magnesium hydroxide, the complex being formed by a steam curing of the magnesium alloy material conducted using (i) at least one compound chosen among diammonium hydrogen phosphate, ammonium dihydrogen phosphate, and triammonium phosphate, and (ii) water.

With the above invention, because the magnesium alloy material in accordance with the present invention is steam-cured using (i) at least one compound chosen among diammonium hydrogen phosphate, ammonium dihydrogen phosphate, and triammonium phosphate, and (ii) water, a layer of a complex made from phosphate-containing magnesium such as dittmarite and the like and from magnesium hydroxide is formed on the surface of the magnesium alloy material. Further, because the magnesium hydroxide has an extremely low solubility, the layer of magnesium hydroxide is extremely strong. In addition, because the magnesium alloy material in accordance with the present invention is steam-cured, it is possible to cause the compound such as diammonium hydrogen phosphate and the like to react in an extremely small molecule state in gas phase. In this way, the reaction efficiency of the compound such as diammonium hydrogen phosphate, ammonium dihydrogen phosphate and the like improves, and the surface of the magnesium alloy material is strongly covered with extremely small molecules of diammonium hydrogen phosphate and the like. As a result, it is possible to give excellent corrosion resistance, shock resistance and the like to the magnesium alloy material in accordance with the present invention.

Further, the magnesium alloy material in accordance with the present invention preferably includes a layer containing the complex made from phosphate-containing magnesium and magnesium hydroxide, the layer having a thickness not less than 10 μm but not more than 150 μm.

In this way, because a layer which includes the complex containing phosphate-containing magnesium and magnesium hydroxide and has a thickness not less than 10 μm but not more than 150 μm is formed on the surface of the magnesium alloy material in accordance with the present invention, the magnesium alloy material is a dense material. As a result, it is possible to use efficiently the magnesium alloy material in accordance with the present invention. In case the thickness of the layer which includes the complex containing phosphate-containing magnesium and magnesium hydroxide and is formed on the surface of the magnesium alloy material in accordance with the present invention is below 10 μm, such a problem occurs that corrosion expands if a defective part of the layer becomes corroded or that corrosion is initiated from even a slight scratch. On the other hand, in case the thickness of the layer which includes the complex containing phosphate-containing magnesium and magnesium hydroxide and is formed on the surface of the magnesium alloy material in accordance with the present invention is over 150 μm, such a problem occurs that the layer becomes cracked as a result of thermal shocks or stress and eventually peels away.

Further, the magnesium alloy material in accordance with the present invention preferably has a complex shape, preferably includes large-sized members, and is preferably subjected to mass treatment.

Further, the magnesium alloy material in accordance with the present invention is preferably formed by a steam curing conducted at a temperature not lower than 80° C. but not higher than 180° C.

In this way, by performing the steam curing at an appropriate temperature, it is possible to improve even further the excellent corrosion resistance, shock resistance and the like of the magnesium alloy material in accordance with the present invention.

In a method for treatment of surface of magnesium alloy material in accordance with the present invention, the magnesium alloy material is treated by a steam curing conducted using (i) at least one compound chosen among diammonium hydrogen phosphate, ammonium dihydrogen phosphate, and triammonium phosphate, and (ii) water, the steam curing being conducted at a temperature not lower than 80° C. but not higher than 180° C.

With the above invention, because a steam curing is performed at a temperature not lower than 80° C. but not higher than 180° C., the surface treatment method in accordance with the present invention makes it possible to maintain a temperature appropriate for curing. Further, in the surface treatment method in accordance with the present invention, because the magnesium alloy material is steam-cured using (i) at least one compound among diammonium hydrogen phosphate, ammonium dihydrogen phosphate, and triammonium phosphate, and (ii) water, a composite layer containing a phosphate-containing magnesium, such as dittmarite and the like, and magnesium hydroxide is formed on the surface of the magnesium alloy material. Then, because a solubility of the magnesium hydroxide is extremely low, the composite layer containing a phosphate-containing magnesium, such as dittmarite and the like, and magnesium hydroxide is extremely strong.

In addition, because a steam curing is performed, the surface treatment method in accordance with the present invention makes it possible to cause the compound such as diammonium hydrogen phosphate to react in an extremely small molecular state in gas phase. In this way, the reaction efficiency of the compound such as diammonium hydrogen phosphate, ammonium dihydrogen phosphate and the like improves, and extremely small molecules of diammonium hydrogen phosphate cover strongly the surface of the magnesium alloy material.

As a result, the surface treatment method in accordance with the present invention makes it possible to manufacture a magnesium alloy material having excellent corrosion resistance, shock resistance and the like.

In particular, with a surface treatment method in which a magnesium alloy material is treated using a generally used anodic oxidation method, because the anodic oxidation is performed by having an electric current pass into a solution, a high potential is required if a coated layer of a surface of the magnesium alloy becomes thick, and this requires a large-scale surface treatment device. In contrast, with the magnesium alloy material surface treatment method in accordance with the present invention, because merely passing steam over a steam-curing layer results in a virtually unlimited increase in temperature, a large-scale surface treatment device is not necessary even if the layer of the magnesium metal alloy has become thicker. As a result, the magnesium alloy material surface treatment method in accordance with the present invention is appropriate to perform a mass treatment/mass production in a determined space.

Further, with the anodic oxidation method, because the coated layer is only attached onto the surface of the magnesium alloy material, the coated layer of the surface of the magnesium alloy material becomes cracked if the magnesium alloy material is bent. As a result, such a problem occurs that the magnesium alloy material on which the coated layer is attached by anodic oxidation cannot be easily put to practical use. In contrast, with the magnesium alloy material surface treatment method in accordance with the present invention, the coated layer of the surface of the magnesium alloy material is in contact with crystal molecules of the surface of the magnesium alloy material. As a result, with the magnesium alloy material surface treatment method in accordance with the present invention, the coated layer of the surface of the magnesium alloy material is unlikely to become cracked, even if the magnesium alloy material is bent.

In addition, with the anodic oxidation method, because the coated layer is only attached onto the surface of the magnesium alloy material, such a problem occurs in cases where the magnesium alloy material is shaped like a pipe that, while it is possible to perform the surface treatment onto an outer part of the pipe, it is not possible to perform the surface treatment onto an inside part of the pipe. Further, in cases where the magnesium alloy material has a non-flat shape, such a problem occurs that it is not possible to perform the surface treatment onto recess parts, spaces, fine cross sections and the like. In contrast, with the surface treatment method in accordance with the present invention, because a steam curing is performed, the compound such as diammonium hydrogen phosphate and the like, which is contained in the steam, is easily put in contact with the magnesium alloy material; as a result, it is possible to perform the surface treatment in an efficient and homogeneous manner, even in the case of a magnesium alloy material having a complex shape such as a pipe shape or a non-flat shape or in the case of a large-scale magnesium alloy material.

Here, for example, Patent Literature 2 discloses a technology in which a layer of phosphate is formed on a surface of the magnesium alloy material by either (i) a method in which a magnesium alloy material is immersed in a diammonium hydrogen phosphate solution, or (ii) a method in which the diammonium hydrogen phosphate solution is sprayed onto the magnesium alloy material. The formation of such a layer of phosphate improves adhesiveness for a subsequent powder coating. However, with this technology, because the magnesium alloy material and the diammonium hydrogen phosphate are made to react in a solution, the reaction is stopped before a thick crystal layer is formed. Further, because the magnesium alloy material and the diammonium hydrogen phosphate are made to react in a solution, impurities are mixed into the solution after surface treatment. As a result, it is difficult to use the diammonium hydrogen phosphate solution repeatedly after the surface treatment, and problems such as a cost increase and an increase in the number of steps occur.

In contrast, with the surface treatment method in accordance with the present invention, because the magnesium alloy material and the diammonium hydrogen phosphate and the like are made to react in steam, diammonium hydrogen phosphate molecules and the like are so small that they can infiltrate inside the magnesium alloy material. Thus, it is possible to control the thickness of the crystal layer. Further, with the surface treatment method in accordance with the present invention, because the magnesium alloy material and the diammonium hydrogen phosphate and the like are made to react in steam, it is possible to repeatedly use the diammonium hydrogen phosphate and the like after the surface treatment. This makes it possible to reduce costs, and to improve efficiency by making the surface treatment a simple operation involving only a limited number of steps.

In a method for treatment of surface of magnesium alloy material in accordance with the present invention, the compound is preferably used as a solution, the solution having a concentration preferably not lower than 1% by weight but not higher than 30% by weight. Further, in a method for treatment of surface of magnesium alloy material in accordance with the present invention, the steam curing is preferably conducted for a duration not shorter than 2 hours but not longer than 30 hours.

In this way, the surface treatment method in accordance with the present invention makes it possible to efficiently steam-cure the magnesium alloy material using the compound.

Further, in a method for treatment of surface of magnesium alloy material surface treatment method in accordance with the present invention, before the steam curing, the magnesium alloy material is put in contact with a solution of a compound, the compound being chosen among diammonium hydrogen phosphate, ammonium dihydrogen phosphate, triammonium phosphate, and phosphoric acid or a derivative of phosphoric acid.

In such a case, treating the magnesium alloy material using a solution of a compound made from at least one of diammonium hydrogen phosphate, ammonium dihydrogen phosphate, triammonium phosphate, and phosphoric acid or a derivative of phosphoric acid provides conditions allowing to form phosphate-containing magnesium such as dittmarite and the like on the surface of the magnesium alloy material. In particular, a treatment made from at least one of diammonium hydrogen phosphate, ammonium dihydrogen phosphate, and triammonium phosphate provides conditions allowing to form a dittmarite having good crystallinity on the surface of the magnesium alloy material. In this regard, it must be noted that the dittmarite is not formed on the surface of the magnesium alloy material when the magnesium alloy material is treated using a solution containing phosphoric acid, phosphorous acid, phosphorin acid, superphosphate, metaphosphate, orthophosphoric acid, pyrophosphoric acid, phosphorous pentoxide, tetraphosphorus decoxide or the like. However, based on an elementary analysis showing that the element phosphate was detected, it can be thought that phosphate-containing magnesium is formed on the surface of the magnesium alloy material. Further, by the subsequent steam curing conducted using the compound, it is possible to cover the surface of the magnesium alloy material with a double layer.

As a result, with the surface treatment method in accordance with the present invention, it is possible to manufacture an improved magnesium alloy material having excellent corrosion resistance, shock resistance and the like.

Further, in a method for treatment of surface of magnesium alloy material in accordance with the present invention, the solution put in contact with the magnesium alloy material preferably has a temperature not lower than 3° C. and not higher than 140° C.

This way, with the surface treatment method in accordance with the present invention, it is possible to maintain a temperature appropriate for the surface treatment.

Further, in a method for treatment of surface of magnesium alloy material in accordance with the present invention, the solution put in contact with the magnesium alloy material preferably has a concentration not lower than 0.1% by weight and not higher than 35% by weight. Further, in a method for treatment of surface of magnesium alloy material in accordance with the present invention, the magnesium alloy material is preferably put in contact with the solution for a duration not shorter than 2 seconds but not longer than 4 hours.

This way, with the surface treatment method in accordance with the present invention, it is possible to perform efficiently, using the solution, the treatment of the magnesium alloy material.

Further, a magnesium alloy material in accordance with the present invention is preferably treated using one of the above methods for treatment of surface of magnesium alloy material.

This way, it becomes possible to manufacture a magnesium alloy material having excellent corrosion resistance, shock resistance and the like, such excellent corrosion resistance, shock resistance and the like being impossible to obtain using conventional surface treatment methods.

A fuller understanding of the other objectives, characteristics and merits of the present invention can be obtained through the ensuing description. Further, the advantages of the present invention will become obvious by referring to the following description taken in conjunction with the accompanying drawings.

### BRIEF DESCRIPTION OF DRAWINGS

FIG. 1 illustrates a steam curing device used in the surface treatment method in accordance with the present invention. (a) of FIG. 1 illustrates an external view, seen diagonally, of the steam curing device; (b) of FIG. 1 illustrates a cross section of an internal part of the steam curing device.

FIG. 2 illustrates an outer appearance of a magnesium alloy material treated by the surface treatment method in accordance with the present invention, following a salt water penetration test.

FIG. 3 illustrates SEM observation results of a magnesium alloy material treated using the surface treatment method in accordance with the present invention.

FIG. 4 is an X-ray diffraction diagram of a magnesium alloy material treated using the surface treatment method in accordance with the present invention.

FIG. 5 is a table illustrating the results of an elementary analysis of a magnesium alloy material treated using the surface treatment method in accordance with the present invention.

FIG. 6 illustrates an external view of a magnesium alloy material treated by being put in contact with a solution and subjected to a salt water penetration test.

FIG. 7 illustrates SEM observation results of a magnesium alloy material treated by being put in contact with a solution.

FIG. 8 is an X-ray diffraction diagram of a magnesium alloy material treated by being put in contact with a solution.

FIG. 9 illustrates SEM observation results of a magnesium alloy material treated using a surface treatment method (anodic oxidation method).

FIG. 10 is an X-ray diffraction diagram of a magnesium alloy material treated using a surface treatment method (anodic oxidation method).

FIG. 11 illustrates external views of a magnesium alloy material. (a) of FIG. 11 illustrates an outer appearance of the magnesium alloy material treated using the surface treatment method in accordance with the present invention; (b) of FIG. 11 illustrates an outer appearance of the magnesium alloy material treated using a surface treatment method (anodic oxidation method).

### REFERENCE SIGNS LIST

1 magnesium alloy material
2 solution
3 stainless steel net
10 steam curing device

### DESCRIPTION OF EMBODIMENTS

The following is a detailed explanation of the present invention. It must be noted that a scope of the present invention is not restricted by the following explanation, and that the present invention can be appropriately modified and implemented beyond the following exemplary embodiments, provided such modifications are not conducted against the gist of the present invention. Specifically, the present invention is not limited to the below embodiments, and various modifications are possible within the scope of the claims below. In other words, embodiments obtained by combining technical means as appropriate within the scope of the claims are comprised within the technical scope of the present invention.

(I) Materials Treated in the Present Invention, Substances Used in the Present Invention and the Like

<Magnesium Alloy Material>

A magnesium alloy material treated in the present invention is not specifically limited, provided that it is an alloy whose main component is magnesium. In other words, alloys including additional elements such as aluminum, zinc, calcium and the like are also included within the scope of the present invention. Further, alloys whose lone component is magnesium are also included within the scope of the present invention.

<Compound>

A compound used in the present invention is made from at least one of the following elements: diammonium hydrogen phosphate, ammonium dihydrogen phosphate, and triammonium phosphate, and phosphoric acid or a derivative of phosphoric acid. The compounds may be used solely or in combination. Among the above compounds, diammonium hydrogen phosphate is preferable, because it easily reacts with magnesium so as to generate magnesium hydroxide.

Further, regarding the surface treatment method in accordance with the present invention, a material other than the compound may be additionally used, provided that this does not hamper characteristics of the magnesium alloy material. There is no particular limitation regarding a method to add such material other than the compound.

<Water>

Steam curing in the present invention uses water. Further, material other than water may be additionally used, provided that this does not hamper characteristics of the magnesium alloy material. A method to add such material other than water is not especially limited.

<Solution of the Compound>

There is no particular limitation regarding a solvent in a solution of the compound used in the present invention. This being said, water is preferable, because it is used in the steam curing. In other words, it is preferable that the solution be an aqueous solution.

<Steam Curing>

The steam curing performed in connection with the present invention is an accelerated curing performed in heated steam. In this case, the wording “curing” refers to a process in which appropriate levels of temperature and humidity are maintained whereby a protective cover layer is formed on the surface of the magnesium alloy. In the surface treatment method in accordance with the present invention, the surface of the magnesium alloy material is protected from corrosion, shocks and the like by steam curing of the magnesium alloy material performed using water and a compound such as diammonium hydrogen phosphate or the like.

<Treatment by the Solution of the Compound>

There is no particular limitation regarding a treatment using the solution of the compound. Such a treatment is conducted using methods such as a method in which the magnesium alloy material is immersed in the solution of the compound such as diammonium hydrogen phosphate, a method in which the solution of the compound such as diammonium hydrogen phosphate is sprayed onto the magnesium alloy material, and the other methods.

(II) Surface Treatment Method in Accordance with the Present Invention

<Surface Treatment Method>

In the magnesium alloy material surface treatment method in accordance with the present invention, the magnesium alloy material is steam-cured in an ambient temperature not lower than 80° C. but not higher than 180° C., using (i) at least one compound among diammonium hydrogen phosphate, ammonium dihydrogen phosphate, and triammonium phosphate, and (ii) water. The wording “ambient temperature” refers to a temperature inside a container in which the steam curing is performed. The ambient temperature is not lower than 80° C. but not higher than 180° C., and preferably not lower than 100° C. but not higher than 140° C. Indeed, such temperature makes it possible to form efficiently the coated layer on the surface of the magnesium alloy.

There is no particular limitation regarding the surface treatment method of the magnesium alloy material in accordance with the present invention. However, the compound is preferably used in solution, and the concentration of the solution is preferably not lower than 1% by weight but not higher than 30% by weight. The steam curing is performed using steam generated by heating the solution. Because such concentration makes it possible to control efficiently the thickness of the coated layer of the surface of the magnesium alloy, the concentration of the solution is preferably not lower than 1% by weight but not higher than 30% by weight, and most preferably not lower than 5% by weight but not higher than 20% by weight.

There is no particular limitation regarding the surface treatment method of the magnesium alloy material in accordance with the present invention. However, the steam curing is preferably performed for a duration not shorter than 2 hours but not longer than 30 hours. In the case that the steam curing is performed for the duration as above, the thickness of the coated layer of the treated magnesium alloy material increases in line with a lengthening of a retention time of the steam curing. As a result, hardness increases (i.e. shock resistance improves), and corrosion resistance improves. Because such retention time makes it possible to form effectively a stabilized coated layer, a duration not shorter than 2 hours but not longer than 30 hours is preferable, and a duration not shorter than 9 hours but not longer than 24 hours is most preferable.

There is no particular limitation regarding the surface treatment method of the magnesium alloy material in accordance with the present invention. However, before performing the steam curing, it is preferable to put the magnesium alloy material in contact with the solution of the compound made from at least one of diammonium hydrogen phosphate and phosphate or one of its derivatives. In other words, the treatment of the magnesium alloy material using the compound made from the diammonium hydrogen phosphate is preferably performed in two phases. In phase 1, a phosphate-containing magnesium having good crystallinity, such as dittmarite and the like, is formed on the surface of the magnesium alloy material by putting the magnesium alloy material in contact with the solution of the compound such as diammonium hydrogen phosphate. In this case, the wording “phosphate-containing magnesium such as dittmarite and the like” refers to a mineral whose main component is magnesium, phosphate and the like. In phase 2, a strong coating layer is formed, by performing a steam curing conducted using (i) the compound such as diammonium hydrogen phosphate and (ii) water on the surface of the magnesium alloy material which has been put in contact with the solution, the composite coated layer containing phosphate-containing magnesium such as dittmarite and the like and magnesium hydroxide. This way, it is possible to improve the corrosion resistance and the shock resistance of the magnesium alloy material.

In the present Description, the wording “phosphate and its derivatives” refers for example to phosphoric acid, phosphorous acid, phosphonrin acid, superphosphate, metaphosphate, orthophosphoric acid, pyrophosphoric acid, phosphorous pentoxide, tetraphosphorus decoxide and the like. In contrast, it must be noted that the wording “phosphate and its derivatives” does not contain diammonium hydrogen phosphate, ammonium dihydrogen phosphate, and triammonium phosphate.

There is no particular limitation regarding the surface treatment method of the magnesium alloy material in accordance with the present invention. However, the solution put in contact with the magnesium alloy material preferably has a temperature not lower than 3° C. but not higher than 140° C. and a concentration not lower than 0.1% by weight but not higher than 35% by weight. The temperature of the solution is preferably not lower than 3° C. but not higher than 140° C. and most preferably not lower than 20° C. but not higher than 120° C., because the phosphate-containing magnesium having good crystallinity such as dittmarite and the like is formed so as to achieve a reaction time as described above, and so as to reduce costs and the like. Further, because such concentration makes it possible to conduct efficiently an interaction within the reaction time in order to form the phosphate-containing compound having good crystallinity such as dittmarite and the like, the concentration of the solution is preferably not lower than 0.1% by weight but not higher than 35% by weight and most preferably not lower than 2% by weight but not higher than 20% by weight.

There is no particular limitation regarding the surface treatment method of the magnesium alloy material in accordance with the present invention. However, the magnesium alloy material is preferably put in contact with the solution of the compound for a duration not shorter than 2 seconds but not longer than 4 hours. The duration of contact is preferably not shorter than 2 seconds but not longer than 4 hours, and most preferably not shorter than seconds but not longer than 2 hours, because this makes it possible to form efficiently the phosphate-containing element having good crystallinity, such as dittmarite and the like.

<Structure of a Device to Put the Present Invention into Practice>

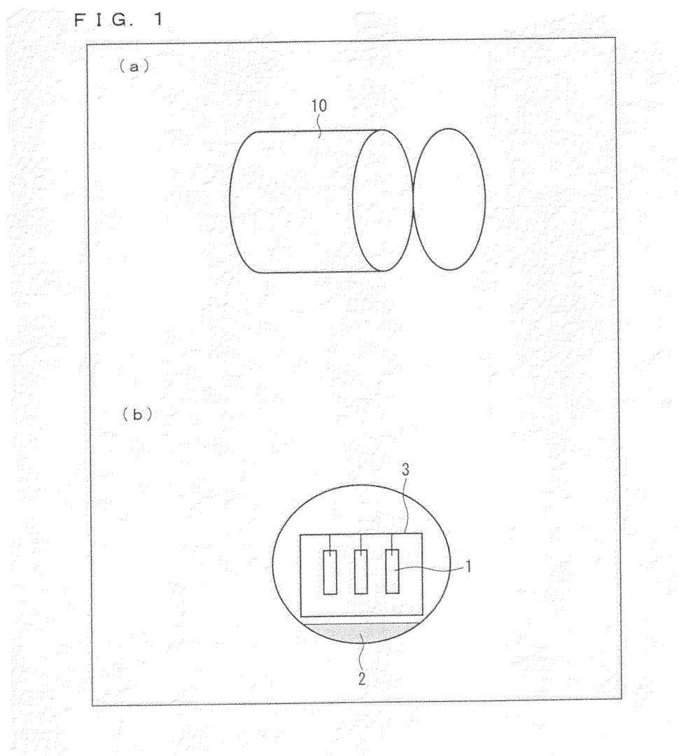

The structure of the device to perform the steam curing in accordance with the present invention is explained as follows, based on (a) and (b) of FIG. 1.

(a) of FIG. 1 is an oblique perspective view illustrating a steam curing device 10 used in the surface treatment method in accordance with the present invention. (b) of FIG. 1 is a cross sectional view illustrating an internal part of the steam curing device 10 used in the surface treatment method in accordance with the present invention.

As shown in (b) of FIG. 1, the internal part of the steam curing device 10 mainly contains a magnesium alloy material 1 and a solution 2 mounted on a stainless steel net 3.

The steam curing in accordance with the present invention is performed by generating steam by an appropriate heating of the solution 2, and by forming a coated layer on a surface of the magnesium alloy material 1 using the generated steam.

(III) Magnesium Alloy Material Treated Using the Surface Treatment Method in Accordance with the Present Invention

A magnesium alloy material treated using the surface treatment method in accordance with the present invention has excellent corrosion resistance, shock resistance and the like. It can be applied, without any additional treatment such as coating and the like, to the following uses: wheels, engine gearbox housings and the like for airplanes; wheels, sumps, automatic transmission cases, metallic core of steering wheels and the like for automobiles; rims, frames and the like for automobiles; material for railway cars.

A coated layer including magnesium hydroxide formed on a surface of the magnesium alloy material in accordance with the present invention has a thickness not less than 10 μm but not more than 150 μm, and preferably not less than 26 μm but not more than 99 μm.

### EXAMPLES

The following is a more detailed explanation of the present invention, based on examples and comparative examples.

[Pre-Treatment Using Solution]

A pre-treated test sample (magnesium alloy material) was manufactured as follows: in several hermetic containers (test sample, 70 cc; external part: stainless steel; internal part: Teflon (registered trademark)), (i) a diammonium hydrogen phosphate solution (manufactured by Sigma-Aldrich Japan Co.) or alternatively a phosphate solution and (ii) a magnesium alloy material (manufactured by KS Technos Co., Ltd.; an extruding material being cut to the following dimensions: length 40 mm, width 20 mm, thickness 1.5 mm) were introduced and processed for 2 hours in a ambient temperature of 120° C.

[Steam Curing]

The steam curing device (test sample) shown in FIG. 1 was introduced inside a drying machine (manufactured by Yamato Scientific Co., Ltd.; product name: “DS44”), and a stainless steel net was positioned inside the steam curing device. In addition, a magnesium alloy material (manufactured by KS Technos Co., Ltd.; extruding material being cut to the following dimensions: length 40 mm, width 20 mm, thickness 1.5 mm) was suspended to the stainless steel net. In a bottom part of the steam curing device, (i) a diammonium hydrogen phosphate solution (manufactured by Sigma-Aldrich Japan Co.), (ii) an ammonium dihydrogen phosphate solution, and (iii) a triammonium phosphate solution or distilled water were then introduced. Then, steam curing was conducted. Conditions under which the steam curing was conducted will be explained below. This way, a treated test sample (magnesium alloy material) was manufactured.

It must be noted that the steam curing may be conducted after the above-described “Pre-treatment using solution”. In cases where the steam curing is conducted after the above-described “Pre-treatment using solution”, in order to cover crystals of phosphate-containing magnesium such as dittmarite and the like which were formed by treatment using the diammonium hydrogen solution or the phosphate solution, a strong surface coated layer is formed by steam curing.

[Material Properties and the Like of the Magnesium Alloy Material]

Evaluation of thickness, hardness and corrosion resistance was conducted regarding the treated test sample. Thickness was measured using a thickness measurement device (manufactured by KEYENCE CORPORATION; product name: “Digital Microscope”).

Hardness was evaluated through a visual assessment of a condition of the test sample after a load was applied. The hardness test was conducted using a hardness measurement device (manufactured by Toyo Seiki Seisaku-Sho, Ltd.; product name: “DUR-O-Test”). Specifically, a condition in which no dents were formed was marked as ++, a condition in which almost no dents were formed was marked as +, and a condition in which dents were formed was marked as −.

Corrosion resistance was evaluated as follows: 5% by weight of a salt water solution (manufactured by Sigma-Aldrich Japan Co.) was introduced inside a 35° C. homothermal water tank (manufactured by Yamato Scientific Co., Ltd.; product name: “BT-23”), the test sample was immersed in the homothermal water tank for 72 hours, and a subsequent condition of the corrosion was visually assessed. Specifically, a condition in which no corrosion occurred was marked as ++, a condition in which almost no corrosion occurred was marked as +, and a condition in which corrosion occurred was marked as −.

[Anodic Oxidation Treatment]

An anodic oxidation treatment (type six; first step) in accordance with a method of anti-corrosion treatment of magnesium alloy JIS H 8651 was performed by inserting the magnesium alloy material in a container containing 100 ml of sodium hydroxide, ethylene glycol, and sodium oxalate, and by carrying out a one-hour treatment. At this time, a liquid temperature was 80° C., and a current density was 2 A/dm². Following the treatment, a treated substance was washed using water, and dried at 80° C. for 30 minutes.

### Summary of Examples 1 to 14

TABLE 1

| | | Steam curing | T | | |
|---|---|---|---|---|---|
| | Contact solution | conditions | (μm) | H | CR |
| Ex. 1 | N/A | 20% by weight diammonium hydrogen | 82 | ++ | ++ |
| | | phosphate solution | | | |
| | | 140° C., 24 hours | | | |
| Ex. 2 | 10% by weight | 20% by weight diammonium hydrogen | 95 | ++ | ++ |
| | diammonium hydrogen | phosphate solution | | | |
| | phosphate solution | 140° C., 24 hours | | | |
| | 120° C., 2 hours | | | | |
| Ex. 3 | 20% by weight | 20% by weight diammonium hydrogen | 99 | ++ | ++ |
| | diammonium hydrogen | phosphate solution | | | |
| | phosphate solution | 140° C., 24 hours | | | |
| | 120° C., 2 hours | | | | |
| Ex. 4 | N/A | 20% by weight diammonium hydrogen | 60 | + | + |
| | | phosphate solution | | | |
| | | 140° C., 9 hours | | | |
| Ex. 5 | N/A | 5% by weight diammonium hydrogen | 58 | + | + |
| | | phosphate solution | | | |
| | | 140° C., 9 hours | | | |
| Ex. 6 | 10% by weight | 20% by weight diammonium hydrogen | 66 | ++ | ++ |
| | diammonium hydrogen | phosphate solution | | | |
| | phosphate solution | 140° C., 9 hours | | | |
| | 120° C., 2 hours | | | | |
| Ex. 7 | 10% by weight | 20% by weight diammonium hydrogen | 46 | + | + |
| | diammonium hydrogen | phosphate solution | | | |
| | phosphate solution | 140° C., 9 hours | | | |
| | 120° C., 2 hours | | | | |
| Ex. 8 | N/A | 20% by weight diammonium hydrogen | 26 | + | + |
| | | phosphate solution | | | |
| | | 140° C., 5 hours | | | |
| Ex. 9 | N/A | 20% by weight diammonium hydrogen | 64 | ++ | ++ |
| | | phosphate solution | | | |
| | | 160° C., 5 hours | | | |
| Ex. 10 | 5% by weight | Distilled water | 73 | + | + |
| | diammonium hydrogen | 140° C., 9 hours | | | |
| | phosphate solution | | | | |
| | 120° C., 2 hours | | | | |
| Ex. 11 | 10% by weight | Distilled water | 80 | ++ | + |
| | diammonium hydrogen | 140° C., 9 hours | | | |
| | phosphate solution | | | | |
| | 120° C., 2 hours | | | | |
| Ex. 12 | N/A | 20% by weight ammonium dihydrogen | 80 | ++ | ++ |
| | | phosphate solution | | | |
| | | 140° C., 24 hours | | | |
| Ex. 13 | N/A | 20% by weight triammonium | 80 | ++ | ++ |
| | | phosphate solution | | | |
| | | 140° C., 24 hours | | | |
| Ex. 14 | 2% by weight phosphate | Distilled water | 20 | ++ | ++ |
| | solution | 140° C., 12 hours | | | |
| | 23° C., 5 seconds | | | | |

Abbreviations: “T” stands for Thickness. “H” stands for Hardness. “CR” stands for Corrosion Resistance. “Ex.” stands for Example.

### Example 1

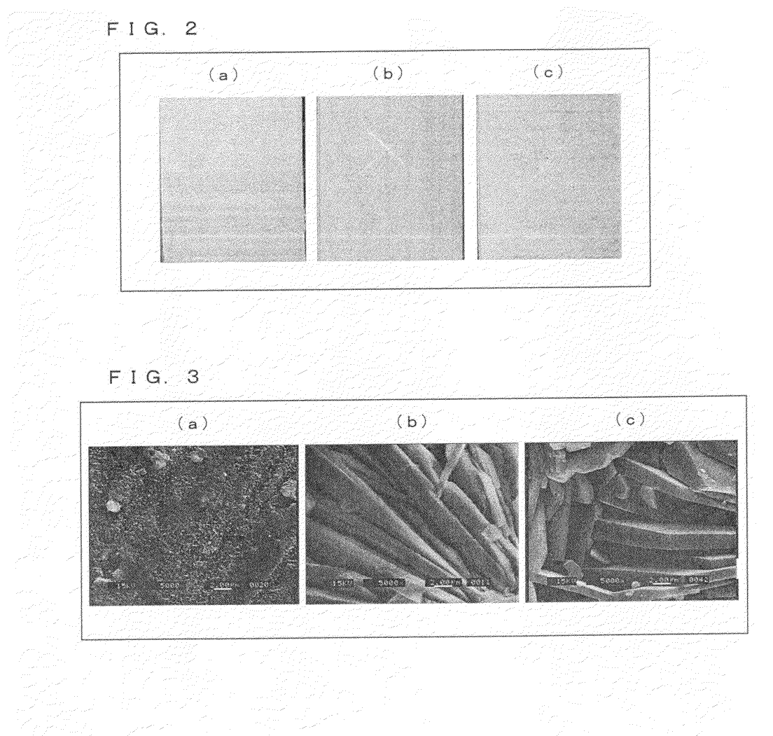

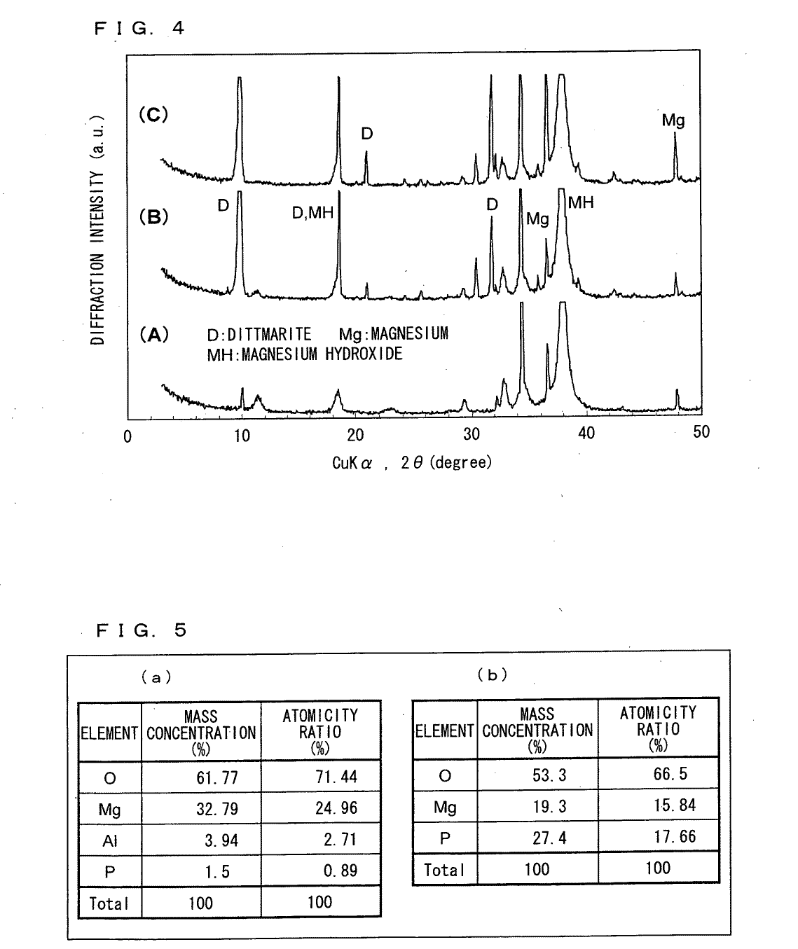

The magnesium alloy material was put in the steam curing device at 140° C., and was treated using a 20% diammonium hydrogen phosphate solution during 24 hours. Post-treatment thickness, hardness and corrosion resistance are shown in Table 1. The test sample after immersion in the salt water solution is shown on (a) of FIG. 2. Results of an SEM observation of the test sample after steam curing are shown on (a) of FIG. 3. As shown on (a) of FIG. 3, small crystals were observable after steam curing. Further, as can be seen in the X-ray diffraction diagram in FIG. 4, peaks of dittmarite slightly appear, and peaks of magnesium hydroxide clearly appear (A of FIG. 4). Further, thanks to results of an elementary analysis shown in (a) of FIG. 5, it was understood that phosphate (P) has a 1.5% mass concentration.

### Example 2

After the magnesium alloy material had been put in contact with a 10% diammonium hydrogen phosphate solution at 120° C. during 2 hours, a resulting material was introduced in the steam curing device at 140° C., and treated using a 20% diammonium hydrogen phosphate solution during 24 hours. Post-treatment thickness, hardness and corrosion resistance are shown in Table 1. The test sample after immersion in the salt water solution is shown on (b) of FIG. 2. Results of an SEM observation of the test sample after steam curing are shown on (b) of FIG. 3. As shown on (b) of FIG. 3, tabular crystals, were observable after steam curing. Further, in the X-ray diffraction diagram in FIG. 4, peaks of dittmarite and peaks of magnesium hydroxide clearly appear (B of FIG. 4).

### Example 3

After the magnesium alloy material had been put in contact with a 20% diammonium hydrogen phosphate solution at 120° C. during 2 hours, a resulting material was introduced in the steam curing device at 140° C., and treated using 20% diammonium hydrogen phosphate solution during 24 hours. Post-treatment thickness, hardness and corrosion resistance are shown in Table 1. The test sample after immersion in the salt water solution is shown on (c) of FIG. 2. Results of an SEM observation of the test sample after steam curing are shown on (c) of FIG. 3. As shown on (c) of FIG. 3, tabular crystals were observable after steam curing. Further, in the X-ray diffraction diagram in FIG. 4, peaks of dittmarite and peaks of magnesium hydroxide clearly appear (C of FIG. 4). Further, thanks to results of an elementary analysis shown in (b) of FIG. 5, it was understood that phosphate (P) has a 27.4% mass concentration.

### Example 4

The magnesium alloy material was put in the steam curing device at 140° C., and was treated using 20% a diammonium hydrogen phosphate solution during 9 hours. Post-treatment thickness, hardness and corrosion resistance are shown in Table 1.

### Example 5

The magnesium alloy material was put in the steam curing device at 140° C., and was treated using a 5% diammonium hydrogen phosphate solution during 9 hours. Post-treatment thickness, hardness and corrosion resistance are shown in Table 1.

### Example 6

After the magnesium alloy material had been put in contact with a 10% diammonium hydrogen phosphate solution at 120° C. during 2 hours, a resulting material was introduced in the steam curing device at 140° C., and treated using a 20% diammonium hydrogen phosphate solution during 9 hours. Post-treatment thickness, hardness and corrosion resistance are shown in Table 1.

### Example 7

After the magnesium alloy material had been put in contact with a 10% diammonium hydrogen phosphate solution at 120° C. during 2 hours, a resulting material was introduced in the steam curing device at 120° C., and treated using a diammonium hydrogen phosphate solution at 20% during 9 hours. Post-treatment thickness, hardness and corrosion resistance are shown in Table 1.

### Example 8

The magnesium alloy material was put in the steam curing device at 140° C., and was treated using a 20% diammonium hydrogen phosphate solution during 5 hours. Post-treatment thickness, hardness and corrosion resistance are shown in Table 1.

### Example 9

The magnesium alloy material was put in the steam curing device at 160° C., and was treated using a 20% diammonium hydrogen phosphate solution during 5 hours. Post-treatment thickness, hardness and corrosion resistance are shown in Table 1.

### Example 10

After the magnesium alloy material had been put in contact with a 5% diammonium hydrogen phosphate solution at 120° C. during 2 hours, a resulting material was introduced in the steam curing device at 140° C., and treated using distilled water during 9 hours. Post-treatment thickness, hardness and corrosion resistance are shown in Table 1.

### Example 11

After the magnesium alloy material had been put in contact with the diammonium hydrogen phosphate solution at 10% at 120° C. during 2 hours, a resulting material was introduced in the steam curing device at 140° C., and treated using distilled water during 9 hours. Post-treatment thickness, hardness and corrosion resistance are shown in Table 1.

### Example 12

The magnesium alloy material was put in the steam curing device at 140° C., and was treated using a 20% ammonium dihydrogen phosphate solution during 24 hours. Post-treatment thickness, hardness and corrosion resistance are shown in Table 1:

### Example 13

The magnesium alloy material was put in the steam curing device at 140° C., and was treated using a 20% triammonium phosphate solution during 24 hours. Post-treatment thickness, hardness and corrosion resistance are shown in Table 1.

### Example 14

After the magnesium alloy material had been put in contact with a 2% phosphate solution at 23° C. during five seconds, a resulting material was introduced in the steam curing device at 140° C., and treated using distilled water during 12 hours. Post-treatment thickness, hardness and corrosion resistance are shown in Table 1.

### Summary of Comparative Examples 1 to 3

TABLE 2

| | | Steam curing | T | | |
|---|---|---|---|---|---|
| | Contact solution | conditions | (μm) | H | CR |
| Comparative | 10% by weight | N/A | 11 | − | − |
| example 1 | diammonium hydrogen | | | | |
| | phosphate solution | | | | |
| | 120° C., 2 hours | | | | |
| Comparative | 30% by weight | N/A | 13 | − | − |
| example 2 | diammonium hydrogen | | | | |
| | phosphate solution | | | | |
| | 120° C., 2 hours | | | | |
| Comparative | JIS H 8651 treatment | N/A | 25 | + | − |
| example 3 | solution Anodic | | | | |
| | oxidation 1 hour | | | | |

Abbreviations: “T” stands for Thickness. “H” stands for Hardness. “CR” stands for Corrosion Resistance.

### Comparative Example 1

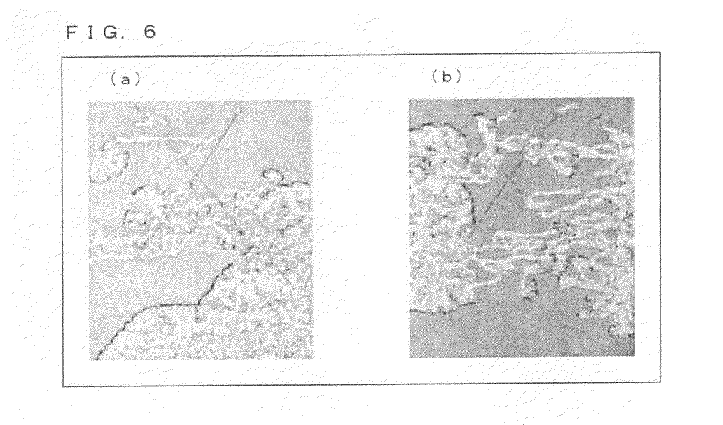

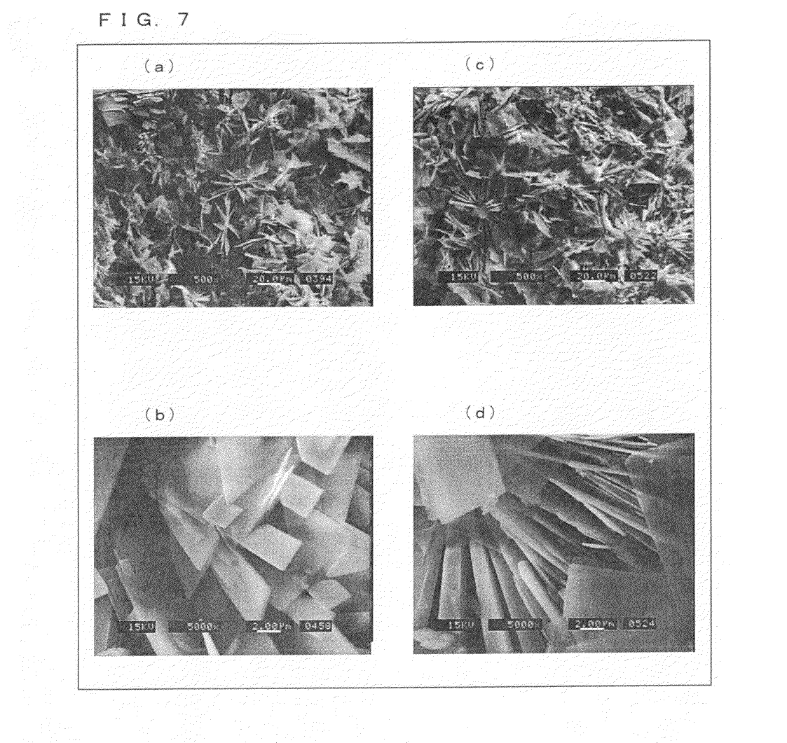

The magnesium alloy material was put in contact with a 10% diammonium hydrogen phosphate solution at 120° C. during 2 hours. Post-treatment thickness, hardness and corrosion resistance are shown in Table 2. The test sample after immersion in the salt water solution is shown on (a) of FIG. 6. As shown on (a) of FIG. 6, a surface of the test sample after the treatment was corroded. Results of an SEM observation of the test sample after treatment are shown on (a) and (b) of FIG. 7, in which (b) of FIG. 7 is an enlarged picture of (a) of FIG. 7. As shown on (a) of FIG. 7, small crystals were observable on the surface after the treatment. Further, as shown on (b) of FIG. 7, fine tubular crystals were observable on the surface after the treatment.

### Comparative Example 2

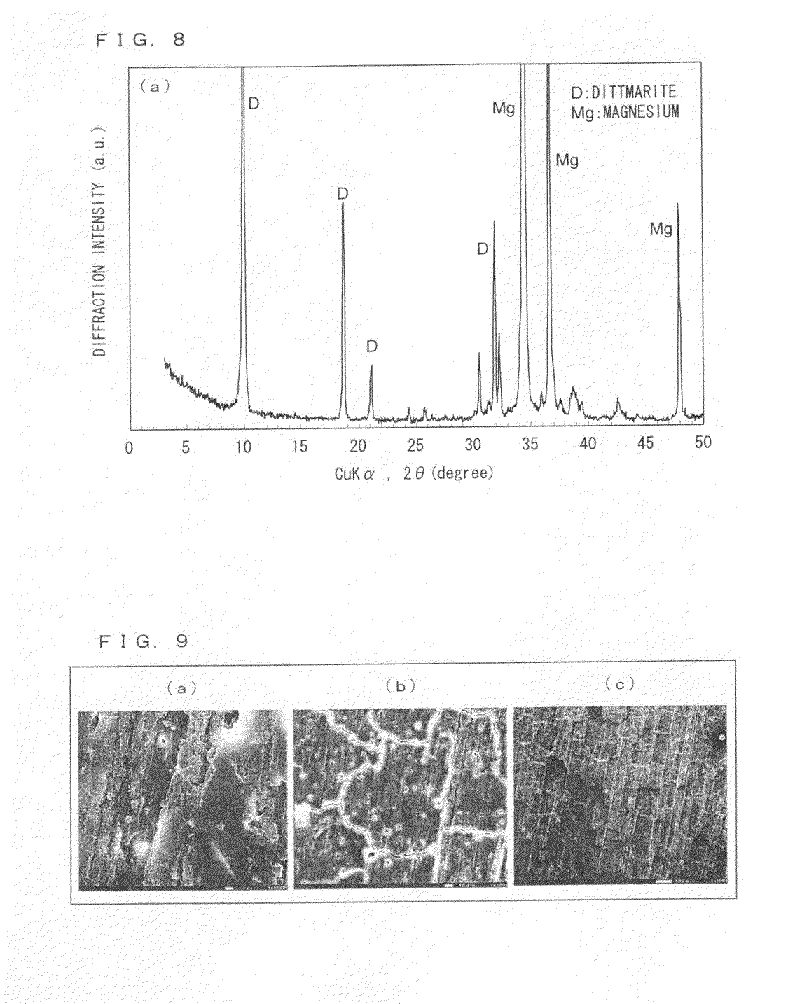

The magnesium alloy material was put in contact with a 30% diammonium hydrogen phosphate solution at 120° C. during 2 hours. Post-treatment thickness, hardness and corrosion resistance are shown in Table 2. The test sample after immersion in the salt water solution is shown on (b) of FIG. 6. As shown on (b) of FIG. 6, a surface after the treatment was corroded similarly to Comparative example 1. Results of an SEM observation of the test sample after treatment are shown on (c) and (d) of FIG. 7, in which (d) of FIG. 7 is an enlarged picture of (c) of FIG. 7. As shown on (c) and (d) of FIG. 7, tubular crystals on the surface after treatment have grown and are thicker than in Comparative example 1. Further, in the X-ray diffraction diagram in FIG. 8, peaks of dittmarite appear.

### Comparative Example 3

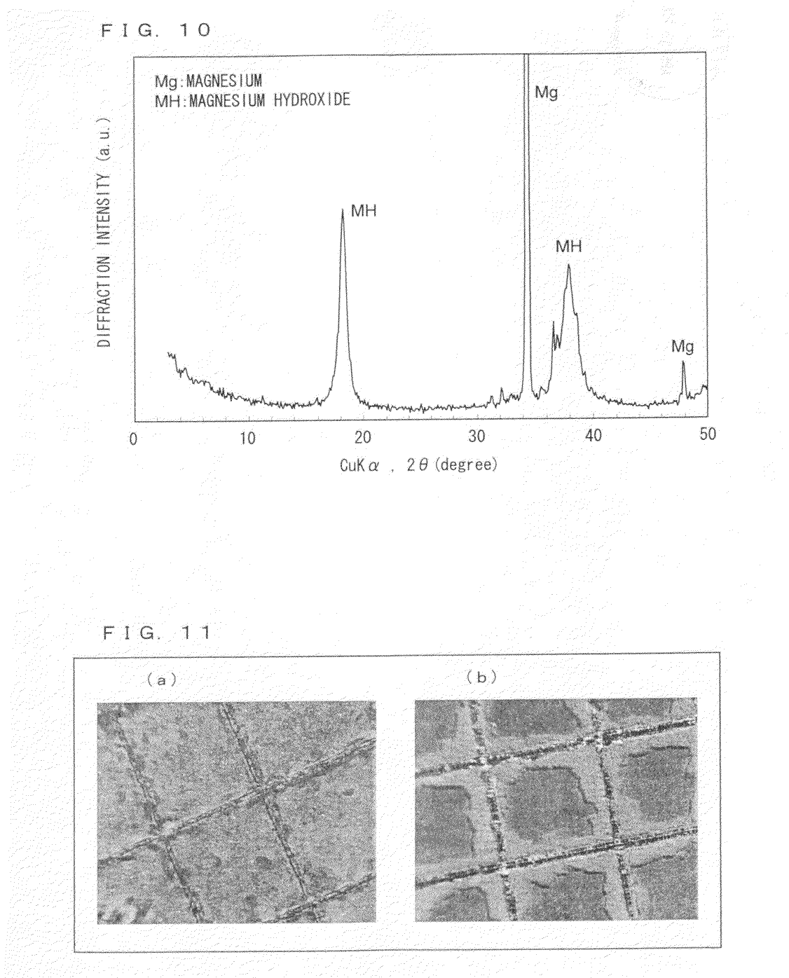

The magnesium alloy material was treated by anodic oxidation treatment (six types, first step) in accordance with a method of anti-corrosion treatment of magnesium alloy JIS H 8651. Post-treatment thickness, hardness and corrosion resistance are shown in Table 2. A surface of the test material after immersion in salt water was corroded. Results of an SEM observation of the test sample after treatment are shown on (a), (b) and (c) of FIG. 9. As shown on (a) of FIG. 9, the surface after treatment was denser. As a result, cracks are likely to appear as a result of heat, pressure, bend and the like, and problems such as detachment and the like occur. This can be inferred from (b) and (c) of FIG. 9. Further, in the X-ray diffraction diagram in FIG. 10, a coated layer formed on the surface by anodic oxidation was made from magnesium hydroxide.

[Results of Peeling Experiment]

(a) of FIG. 11 illustrates an outer appearance of a magnesium alloy material, treated by steam curing, after a peeling experiment. (b) of FIG. 11 illustrates an outer appearance of the magnesium alloy material, treated by anodic oxidation, after a peeling experiment.

As shown in (b) of FIG. 11, in the case of the magnesium alloy material treated by anodic oxidation, cut parts of the magnesium alloy material show gloss of magnesium metal on the surface, and a surrounding area around the cut parts was peeled off. This did not appear in the case of the magnesium alloy material treated by steam curing shown on (a) of FIG. 11. The magnesium alloy material treated by steam curing had a hard surface, and detached parts were not observed.

As described above, in a magnesium alloy material in accordance with the present invention and in a method for treatment of surface of magnesium alloy material in accordance with the present invention, a magnesium alloy material contains a complex made from a phosphate-containing magnesium, such as dittmarite and the like, and magnesium hydroxide, the complex being formed by a steam curing of the magnesium alloy material conducted using (i) at least one compound chosen among diammonium hydrogen phosphate, ammonium dihydrogen phosphate, and triammonium phosphate; and (ii) water.

Consequently, it is possible to provide a magnesium alloy material having excellent corrosion resistance, shock resistance and the like, and to provide a magnesium alloy material surface treatment method making it possible to manufacture a magnesium alloy material having excellent corrosion resistance, shock resistance and the like.

The detailed explanations of the invention which were given above in connection with concrete embodiments and examples are merely intended to clarify the technical contents of the present invention. The present invention should not be construed to be limited to these examples and embodiments, and various modifications can be exercised within the spirit of the invention and the scope of the following claims.

### INDUSTRIAL APPLICABILITY

The magnesium alloy material surface treatment method in accordance with the present invention makes it possible to manufacture a magnesium alloy material having excellent corrosion resistance, shock resistance and the like. As a result, without any additional treatment such as coating, it can be applied to a wide range of uses in metal mechanical industry. Specifically, it can be applied to airplane wheels, engine gearbox housings and the like; automobile wheels, sumps, automatic transmission cases, metallic core of steering wheels and the like; automobile rims, frames and the like; material for railway cars.

1. A magnesium alloy material containing a complex made from phosphate-containing magnesium and magnesium hydroxide,
the complex being formed by a steam curing of the magnesium alloy material conducted using:
at least one compound chosen among diammonium hydrogen phosphate, ammonium dihydrogen phosphate, and triammonium phosphate; and
water.

2. The magnesium alloy material according to claim 1, comprising a layer containing the complex made from phosphate-containing magnesium and magnesium hydroxide,
the layer having a thickness not less than 10 μm but not more than 150 μm.

3. A method for treatment of surface of magnesium alloy material, the method comprising:
performing steam curing of the magnesium alloy material by using:
at least one compound chosen among diammonium hydrogen phosphate, ammonium dihydrogen phosphate, and triammonium phosphate; and
water,
the steam curing being conducted at a temperature not lower than 80° C. but not higher than 180° C.

4. The method according to claim 3, wherein the compound is used as a solution,
the solution has a concentration not lower than 1% by weight but not higher than 30% by weight.

5. The method according to claim 3, wherein the steam curing is conducted for a duration not shorter than 2 hours but not longer than 30 hours.

6. The method according to claim 3, comprising, before the step of performing the steam curing:
putting the magnesium alloy material in contact with a solution of a compound,
the compound being chosen from the group consisting of diammonium hydrogen phosphate, ammonium dihydrogen phosphate, triammonium phosphate, and phosphoric acid or a derivative of phosphoric acid.

7. The method according to claim 6, wherein the solution put in contact with the magnesium alloy material has a temperature not lower than 3° C. but not higher than 140° C.

8. The method for treatment of surface of magnesium alloy material according to claim 6, wherein the solution put in contact with the magnesium alloy material has a concentration not lower than 0.1% by weight but not higher than 35% by weight.

9. The method for treatment of surface of magnesium alloy material according to claim 6, wherein the putting the magnesium alloy material in contact with the solution is conducted for a duration not shorter than 2 seconds but not longer than 4 hours.

10. A magnesium alloy material treated using a method for treatment of surface of magnesium alloy material according to claim 3.
